(19) United States
(12) Patent Application Publication
(10) Pub. No.: US 2025/0023662 A1
(43) Pub. Date: Jan. 16, 2025

(54) MODULATION USING VARIABLE-LENGTH BIT MAPPINGS

(71) Applicants: Massachusetts Institute of Technology, Cambridge, MA (US); National University of Ireland Maynooth, Maynooth (IE)

(72) Inventors: Muriel MEDARD, Belmont, MA (US); Kenneth R. DUFFY, Belmont, MA (US); Basak OZAYDIN, Cambridge, MA (US)

(73) Assignees: Massachusetts Institute of Technology, Cambridge, MA (US); National University of Ireland Maynooth, Maynooth (IE)

(21) Appl. No.: 18/705,203

(22) PCT Filed: Nov. 10, 2022
(86) PCT No.: PCT/US2022/049488

§ 371 Date: Apr. 26, 2024

Related U.S. Application Data
(60) Provisional application No. 63/278,976, filed on Nov. 12, 2021.

(51) Int. Cl. H04L 1/00; H04L 25/03

(52) U.S. Cl. CPC H04L 1/0045; H04L 1/0041; H04L 1/0064; H04L 25/03171

(57) ABSTRACT

Systems and methods disclose a practical implementation of optimal modulation (OM) for the Complex Additive White Gaussian Noise (CAWGN) channel. At the sender, we map from uniform distributions of data to non-uniform distributions of points in constellations by using a technique inspired by Huffman codes. We replace Gray codes with a bit mapping suited to our constellations, where different points may map to string of bits of different lengths. At the receiver, we perform distribution-aware detection. The differing lengths of bits for modulation points can used as a simple checking mechanism that, when combined with guessing random additive noise decoding (GRAND), yields bit-error-rate (BER) advantages.

### BACKGROUND

Modulation is the task of mapping bit sequences to signals to transmit them across a communication channel. In vector notation, these signals correspond to complex points on the in-phase/quadrature (“I-Q”) plane and, depending on their location and the probability distribution over them, modulation schemes are divided into two classes: uniform and non-uniform. Uniform constellations consist of signal points that are symmetric with respect to the axes of the I-Q plane. Moreover, points exhibit a uniform distribution. In the latter type of constellations, the non-uniformity is achieved by a non-uniform distribution over the signal points or by asymmetries in the locations of the constellation points on the I-Q plane. Quadrature amplitude modulation (“QAM”), a commonly used modulation scheme in various applications including 5G, LTE, and IEEE 802.11 standards, is an example of uniform modulation schemes.

In 1971, Joel G. Smith proved that under peak and average power constraints, the optimal channel input distribution of a scalar Gaussian channel consists of a set of discrete points and the distribution over them can be determined through convex optimization. After that, similar results were shown for various channels. In a coherent additive white Gaussian noise (“CAWGN”) channel, with maximum and average power restrictions, the optimal channel input distribution is discrete in amplitude and continuous in phase (“DACP”). In other words, the distribution is a set of concentric circles around the origin. Later, it was displayed that this continuous distribution can be discretized with a small loss. All in all, designing constellations for optimal modulation (“OM”) is a known process. Yet, despite the gain these tailored constellations can achieve, they are not employed in communications due to the lack of a practical structure that map the bit sequences to these non-uniform constellation points.

### SUMMARY OF DISCLOSED EMBODIMENTS

Embodiments encompass both a constellation design methodology, and transmitter and receiver blocks that efficiently utilize the resulting constellations. In the first step of the design procedure, we modify a previously proposed cutting plane algorithm to find the optimal distribution over a set of fixed energy levels. In the second step, we introduce a greedy quantization algorithm to obtain realizable modulation schemes. Our modulator design solves the problem of mapping to a non-uniform distribution using variable-length bit mappings. To handle such variable-length mappings, we also introduce a new demodulator. We evaluate the theoretical and the uncoded simulation performance to quantify the gain yielded by our scheme.

Accordingly, one embodiment comprises a method of demodulating a received signal that encodes a plurality of symbols. The method includes forming a non-uniform constellation of points in a space, each point corresponding to a receivable symbol having a bit length. At least two such symbols differ in their probability of reception and at least two such symbols have different bit lengths. The method includes demodulating the received signal according to the constellation to produce a sequence of points in the constellation that correspond to a plurality of received symbols, concatenating the bit sequences of the plurality of received symbols to produce an output bit sequence, and outputting the output bit sequence. Other embodiments include corresponding computer systems, apparatus, and computer programs recorded on one or more computer storage devices, each configured to perform the actions of the methods.

The method may include receiving, from a modulator, data indicating a transmission bit length.

Concatenating the bit sequences may include, when a total length of the produced output bit sequence differs from the transmission bit length: guessing a noise associated with each point in the sequence of points; selecting, as a function of the guessed noises, (a) a symbol in the sequence of received symbols, and (b) a replacement symbol having a different bit length, where the selected symbol and the selected replacement symbol have different bit lengths; and replacing the selected symbol with the selected replacement symbol, when doing so would result in an output bit sequence having a bit length that equals the transmission bit length.

Selecting the symbol in the sequence of received symbols may include selecting the symbol having a least likelihood of reception according to the guessed noises.

The output bit sequence may include a source encoding of a codeword. The source encoding may include a Huffman encoding or algebraic code.

Forming the constellation may include each point corresponding to a transmittable symbol having a bit sequence that is chosen on the basis of a Huffman distance between the bit sequence and the bit sequences of symbols that correspond to one or more nearest constellation points.

Forming the constellation in the space may include assigning, to a given point, a symbol having a given bit sequence length when the point closest in the space to the given point corresponds to a symbol having the given bit sequence length.

Forming the non-uniform constellation of points may include forming rings of points in the plane, each ring of points having points that are equiangularly or quasi-equiangularly distributed.

Forming the non-uniform constellation of points may include increasing a minimum distance between points in adjacent rings

Producing the sequence of points in the constellation includes performing a maximum a posteriori (map) or quasi map estimation.

Implementations of the described techniques may include hardware, a method or process, or computer software on a computer-accessible medium.

Another embodiment comprises a system for demodulating a signal that encodes a plurality of symbols. The system has a receiver for receiving the signal according to a non-uniform constellation of points in a space, each point corresponding to a receivable symbol having a bit length, wherein at least two such symbols differ in their probability of reception and at least two such symbols have different bit lengths. The system also has a demodulator for demodulating the received signal according to the constellation to produce a sequence of points in the constellation that correspond to a plurality of received symbols, and for concatenating the bit sequences of the plurality of received symbols to produce an output bit sequence, and for outputting the output bit sequence.

The demodulator may be configured for, when a total length of the produced output bit sequence differs from a transmission bit length: guessing a noise associated with each point in the sequence of points; selecting, as a function of the guessed noises, (a) a symbol in the sequence of received symbols, and (b) a replacement symbol having a different bit length, wherein the selected symbol and the selected replacement symbol have different bit lengths; and replacing the selected symbol with the selected replacement symbol, when doing so would result in an output bit sequence having a bit length that equals the transmission bit length.

The demodulator may be configured for selecting the symbol in the sequence of received symbols by selecting the symbol having a least likelihood of reception according to the guessed noises.

The demodulator may be configured for outputting an output bit sequence comprising a source encoding of a codeword. The source encoding may be a Huffman encoding or algebraic code.

In the non-uniform constellation of points, each point may correspond to a transmittable symbol having a bit sequence that is chosen on the basis of a Huffman distance between the bit sequence and the bit sequences of symbols that correspond to one or more nearest constellation points.

The non-uniform constellation of points in the space may comprise, for a given point, a symbol having a given bit sequence length when the point closest in the space to the given point corresponds to a symbol having the given bit sequence length.

The non-uniform constellation of points may comprise rings of points in the plane, each ring of points having points that are equiangularly or quasi-equiangularly distributed.

The demodulator producing the sequence of points in the constellation may include the demodulator performing a maximum a posteriori (MAP) or quasi MAP estimation.

It is appreciated that the concepts, techniques, and structures disclosed herein may be embodied in other ways, and the above summary of disclosed embodiments should not be viewed as limiting, but as merely illustrative.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1 depicts a non-uniform modulation scheme both according to the position and the non-uniform probabilities of the points;

FIG. 2 is an example Huffman tree built for an 18-point constellation designed at N₀=1;

FIG. 3 shows decision regions for the constellation in FIG. 1;

FIG. 4 is a theoretical performance of the constellation for Eₛ/N₀=6 dB;

FIG. 5 is the gain in E_{b}/N₀ that is obtained in uncoded setting with the proposed system;

FIG. 6 the uncoded performance of constellations designed for Eₛ/N₀=26 dB in comparison with QAM of the same sizes;

FIG. 7 is a flowchart showing a method of modulating a plurality of symbols for transmission in accordance with an embodiment;

FIG. 8 is a flowchart showing a corresponding method of demodulating a received signal that encodes a plurality of symbols in accordance with an embodiment; and

FIG. 9 schematically shows a system for transmitting data symbols between a data producer and a data consumer in which embodiments may be advantageously used.

### DETAILED DESCRIPTION OF VARIOUS EMBODIMENTS

CHANNEL MODEL AND NOTATION. The channel of interest in our constellation and system design is the complex Gaussian channel with average and peak power constraints on the input. Let X and Y be the complex channel input and output respectively and N be a complex Gaussian noise, i.e. N˜N_{C}(0, σ²). Then the channel is modeled as

$$Y = X + N \qquad ( 1 )$$

with E[X²]≤σ²_{P} and |X|≤M. N is independent from X, and distributed independent and identically with independent in-phase and quadrature components. The capacity of this channel subject to these conditions is given by:

$$C = {max}_{X} I ( X ; Y ) \qquad ( 2 )$$

where max_{X} indicates finding the maximum of I(X;Y) over different distributions of the channel input, X. Let X=re^{jθ} and Y=Re^{jφ}. In the case of a non-unit noise variance, we may simply normalize the noise, so suppose that the variances of both the imaginary and the real part of the noise is 1. Then the joint conditional distribution of R given r is written as:

$${f}_{R \vert r} ( R \vert r ) = exp ( - \frac{( {R}^{2} + {r}^{2} )}{2} ) {I}_{0} ( Rr ) \qquad ( 3 )$$

where I₀(x) is the modified Bessel function of the first kind and of 0th order. The following lemma provides how fast it increases asymptotically.

$$Lemma 1 : For large \vert z \vert and α = 4 {n}^{2} , \\ {I}_{n} ( z ) ∼ \frac{{e}^{z}}{\sqrt{2 π z}} ( 1 - \frac{α - 1}{8 z} + O ( {z}^{- 2} ) ) . \qquad ( 4 )$$

This asymptotic behavior is useful in making numerical approximations and performing some simplifications when we are designing close-to-optimal constellations in the following, if the multiplication Rr is large.

CONSTELLATION DESIGN. We now consider two separate optimization problems to construct our close-to-optimal constellations: Finding the probability distribution over a set of energy levels, and determining the number and the phases of the quantized points to represent the resulting continuous distribution. Solving the first problem yields a DACP distribution, and these continuous distributions are converted into realizable constellations with the latter.

Discrete Amplitude Continuous Phase Channel Input Distributions. We use a cutting plane algorithm to optimize the probability distribution over a fixed set of energy levels, A, provided by the user. This algorithm makes use of the following expression for the mutual information between the channel input and the output:

$$I ( μ ) = 〈 μ , {g}_{μ} 〉 \qquad ( 5 )$$

where g_{μ} is the channel sensitivity function. One then maximizes the channel capacity as the following convex optimization problem:

$$max c \\ s . t . 〈 μ , {g}_{{u}_{i}} 〉 \geq c \\ 0 \leq i \leq n - 1 \\ μ ∈ M \qquad ( 6 )$$

This algorithm, and the procedure to utilize the complex Gaussian channel with it, are explained in J. Huang and S. P. Meyn, “Characterization and computation of optimal distributions for channel coding,” IEEE Transactions on Information Theory, 51(7):2336-2351, 2005. We apply one crucial modification to the original procedure. As the magnitude of N₀ decreases, the exponential term in f_{R|r}(R|r) plummets whereas the modified Bessel function of the first kind increases quite steeply. This results in numerical difficulties in high SNR designs. To solve this issue, we utilize Lemma 1 and approximate the modified Bessel function of the first kind, I₀(z), as

$${e}^{Z} / \sqrt{2 π z} .$$

This yields simplifications in the exponential terms when calculating <μ, gμ> in (6) and removes the numerical 0×∞ indeterminate form in numerical calculations of gμ.

Quantization. The previous section provides us with the probabilities over each energy level in set A. It has been proved that every energy level a∈A can be represented by kₐ points where

$${k}_{a} = ⌊ \frac{\sqrt[3]{{a}^{2} {p}_{A} ( a )}}{{\sum }_{\overline{a} ∈ A} \sqrt[3]{{\overline{a}}^{2} {p}_{A} ( \overline{a} )}} K ⌋ . \qquad ( 7 )$$

Here, K is the desired constellation size and p_{A}(a) is the total probability of the energy level a, as a ring in the DACP distribution.

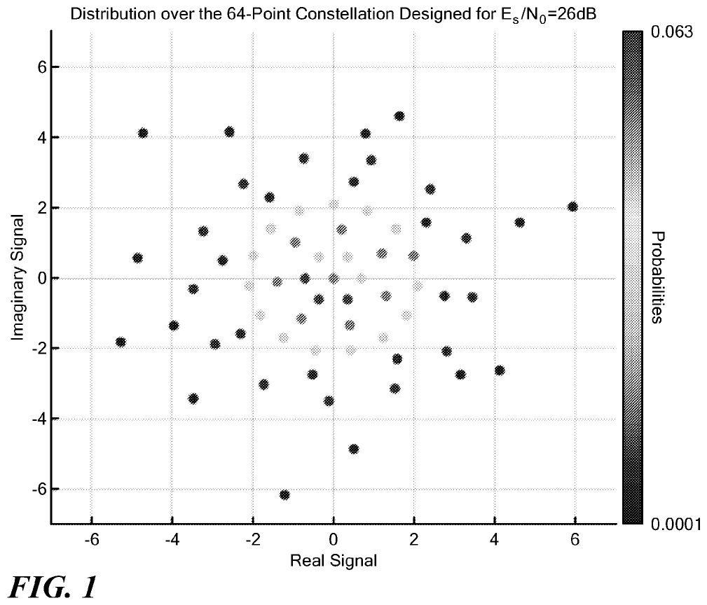

Each point on the energy level a has the same probability, which is equal to p_{A}(a)/kₐ. After determining the number of points on each energy ring, it is known to divide the energy level a∈A into kₐ arcs of the same length starting from the x-axis of the I-Q plane and place the points between these arcs. Yet, we observed that such a quantization is suboptimal, and instead we implemented a greedy algorithm to determine the quantized constellation points. This algorithm, described below, aims to maximize the minimum distances between each energy level. It achieves this by first placing every ring starting from the x-axis, then it determines how much ring i should be rotated to maximize the minimum distance between the ring i and the ring i-1. FIG. 1 is a 64-point constellation designed according to this procedure for Eₛ/N₀=26 dB.

MODULATOR DESIGN. Huffman Tree Mapping. We model the bits received by the modulator as independent and identically distributed (i.i.d.) with uniform probability mass function (p.m.f.). This is a reasonable assumption for the uncoded case due to the compression algorithms employed by codes described by Shannon. With random codes, we can map the K-bit uniformly distributed source encoder output to N-bit uniformly distributed channel encoder output.

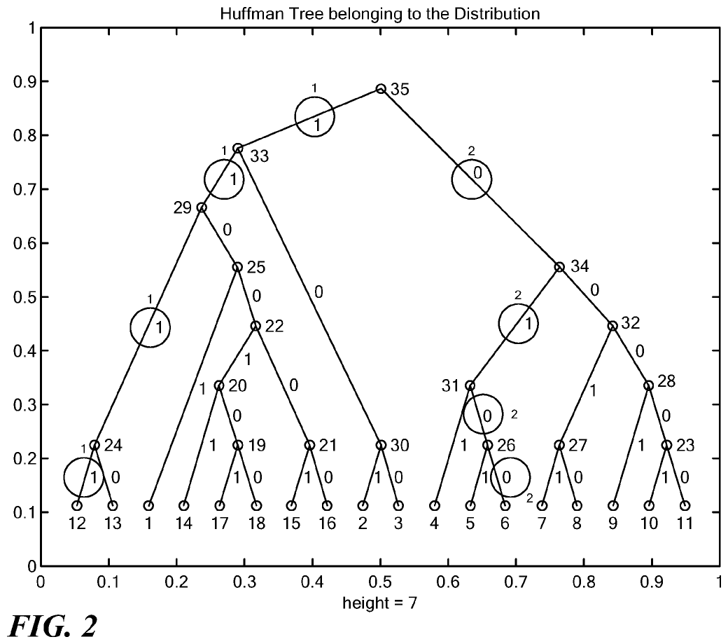

Huffman coding is a well-known source encoding algorithm that produces an optimal code by assembling a binary coding tree with each branch representing either 0 or 1, according to the probabilities of each alphabet member. FIG. 2 provides one such code tree. A symbol is mapped to the bit sequence obtained by reading the bits along the branches on the path from the root node to the leaf node representing the particular symbol. The symbol numbering in FIG. 2 is made starting from the origin to the outmost energy level of the constellation.

Huffman coding yields a 1-1 mapping between the symbols and the bit sequences, so rather than mapping symbols to bits, we reverse the process and map bit sequences to symbols. Namely, after growing the binary code tree, we follow the bit sequences coming from the previous block of the communication system along the tree branches. When we arrive at a leaf, we transmit the symbol corresponding to that particular leaf and restart following the branches from the root according to the remaining bits.

Consider the tree in FIG. 2 and suppose that from the channel encoder, the bit sequence “11110100001” has arrived at the modulator. Starting from the root node, node number 35, we follow the bits on the branches. The first received bit is 1, advancing along the branch that represents 1, we arrive at node 33. Carrying on in this way, we see that after the first 4 bits, we end up at symbol 12. Hence, the first symbol that the transmitter sends is symbol 12. The first bit after we arrive at a leaf is 0. Again, starting from node 35, we move along branch 0 to arrive at node 34. The substring “0100” leads to 6. So, after 12, we transmit 6. The remaining substring after attaining two symbols is “001”. According to the FIG. 2, this last bit sequence does not reach any of the leaves.

To solve the issue of unmapped bits, we can use extra padding. We choose a padding scheme by assuming that the channel encoder uses a systematic random code. Let the length of the messages received in the channel encoder from the source encoder be K. In embodiments using systematic codes, the first K bits of the output codeword are equal to the message itself and the remaining part consists of parity bits obtained using random parity vectors. We divide the parity vectors into two classes: fixed and padding. We set the number of both kinds of parity columns as N_{f} and Nₚ, respectively. When forming the output codeword in the channel encoder, all the parity bits coming from the fixed parity vectors are included in the codeword. Opposingly, we use the parity bits coming from the padding columns to reach a leaf node in the binary code tree if the message and fixed parity bits result in a situation as in the example given above. The final codeword has a size of at least K+N_{f} bits, but the number of bits transmitted for each message may vary depending on the number of unmapped bits of the message and fixed parity bits. Nₚ should be greater than or equal to one less the length of the longest bit sequence representing a symbol. Algorithm 1 below illustrates the steps to perform the non-uniform mapping of an input message to transmitted symbols.

Algorithm 1: Mapping Algorithm

| Input: | p_{X} (x): probabilities of the constellation points |
|---|---|
| | K, N_{f}, Nₚ: length of message, the fixed |
| portion, and the padding portion of the parity bits | |
| | c: codeword vector of length (K + N_{f} + Nₚ) |
| Result: | y: vector of transmitted symbols |
| | n: number of bits represented by y |
| Initialization: H ← Generate the Huffman tree of the | |
| distribution p_{X} (x) | |
| | n← 0, k← 0 |
| repeat | |
| \| y[k], l ← map(c[n : K + N_{f} + Nₚ], H) /* l is | |
| \| | returned from mapping function |
| \| | and holds the number of bits the |
| \| | resulting symbol represents */ |

| n ← n + l, k ← k + 1
until n≥ K + N_{f};

The “map” subroutine in Algorithm 1 tracks bits along the Huffman tree H. For convenience, we assume that the generator matrix of the above-described system is of the following form:

$$G = [ {I}_{( K \times K )} {P}_{f ( K \times {N}_{f} )} {P}_{P ( K \times {N}_{p} )} ] \qquad ( 8 )$$

where K, N_{f}, and Nₚ are as described above. P_{f} and Pₚ are matrices consisting of the fixed and padding parity columns, respectively. I_{K×K} is the identity matrix of size K. In the uncoded simulations described herein, instead of using padding bits obtained according to matrix Pₚ, we appended randomly generated extra padding bits at the end of the message.

As the bit sequence received by the modulator is assumed to be uniformly and independently distributed, when we move towards leaves, each branch we pass contributes by a factor of ½ to the probability of that particular leaf node. This situation indicates that rather than having the exact distribution of our constellation design, we have a power-of-two approximation of them. To exemplify this situation, in the final distribution p_{X}(18)=1/128, as we pass 7 branches.

Bit mapping. The matter of how the modulator should map bits to constellation points therefore naturally arises in our scheme. The Huffman tree method yields bit mappings of variable length. In many communication systems, a Gray code is commonly used for mapping constellation points, which all have the same number of bits. We therefore develop a different bit mapping algorithm, suited to optimal modulation.

We rearrange bit sequences of the same length such that the constellation points differ in only one bit if its closest point also has a bit sequence of equal bit numbers. The algorithm sweeps through the constellation points and checks whether the closest constellation point is mapped to a bit sequence of the same length. If the lengths are the same, we check the Hamming distance between the bit mappings of these sequences. If the Hamming distance is only one, then we move onto the next constellation point. However, if the Hamming distance is greater than one, we inspect other bit sequences of the same length until an exchangeable bit sequence is detected or all the same-length bit sequences are exhausted.

Let the list of the bit sequences that have the same length as the current constellation point be denoted by [symbol] . Suppose that the closest neighbor of the symbol s, call it sⱼ, is more than one Hamming distance away from s and the algorithm found out that bit sequence mapped to sⱼ, denote it by lⱼ, is in [symbol] . Let lᵢ∈ [symbol] . We first check lᵢ's Hamming distance from the mapping of s. If the Hamming distance is more than one, then we move onto the next symbol whose bit mapping is in [symbol] . If the distance is one bit, we check whether lᵢ is exchangeable with lⱼ. A bit sequence is deemed as exchangeable if it satisfies one of the following criteria: (a) The Hamming distance between the bit mappings of sᵢ and its closest neighbor is more than one; or (b) The Hamming distance between the bit mappings of sᵢ and its closest neighbor is one, but the Hamming distance between the mapping of sⱼ and the closest neighbor of sᵢ is also one.

If one of the above conditions is met, the algorithm swaps the bit sequences corresponding to sⱼ and sᵢ. If no exchangeable symbol is encountered despite having its nearest neighbor more than one bit away, the algorithm does not change anything and moves onto the next point.

DEMODULATION AND LENGTH-BASED CORRECTION. Decision regions for the constellation. Unlike the case in the uniform constellations, in optimal modulation, channel input no longer comes from a uniform distribution. The demodulation process needs to incorporate the nonuniform prior distribution of the symbols which can be done via Bayesian Inference. In the maximum a posteriori (“MAP”) estimation, for a channel output to be labeled as symbol sᵢ, the following inequality must be satisfied:

$$\frac{{f}_{Z \vert X} ( z \vert {s}_{i} ) P ( X = {s}_{i} )}{{f}_{Z \vert X} ( z \vert {s}_{j} ) P ( X = {s}_{j} )} \geq 1 ∀ j \neq i \qquad ( 9 )$$

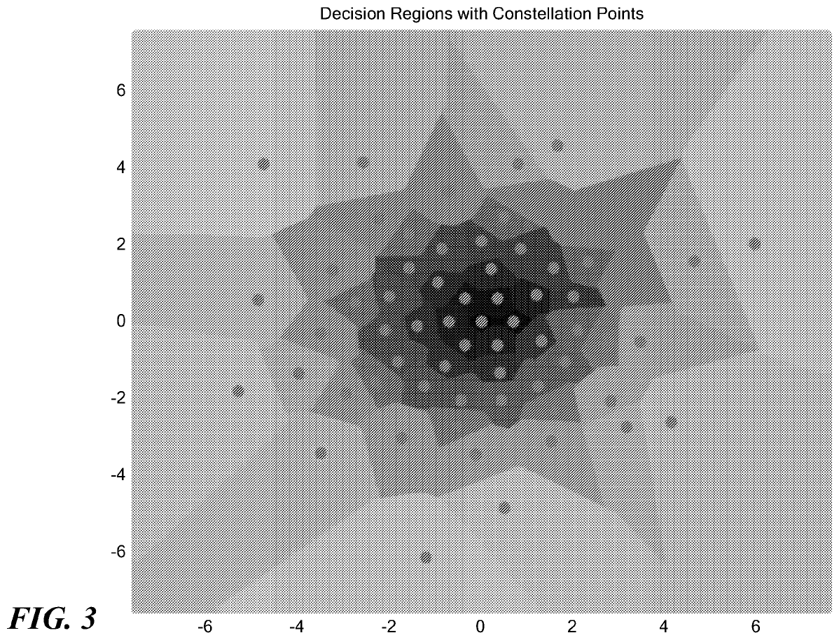

The decision regions of the constellation in FIG. 1 obtained from the MAP estimates are as shown in FIG. 3. The demodulator calculates f_{Z|X}(z|si)P(X=sᵢ) for each of the received symbols and decides in which decision region the received signal lies depending on for what value of i the quantity f_{Z|X}(z|sᵢ)P(X=si) is maximized. Due to the varying bit lengths of symbols, after MAP estimation, the bit sequences may differ from the transmitted bit sequence in terms of length.

Length correction. For short enough messages, the probability of having more than a single symbol error in the transmission can be negligible. In this setting, it is observed that if there is a difference in the length of the transmitted and the received symbol sequences, mostly there is a single erroneous symbol. Moreover, this single error is the product of shifting to a symbol on a neighboring ring, i.e. one energy level up or down. Thus, finding the errored-symbol and correcting it to a right symbol or at least to a symbol of the same size may in fact decrease the number of symbol and bit errors. At this point, we draw inspiration from the recently introduced decoding scheme GRAND, which is based on “guessing” random additive noise and is described in U.S. Pat. Nos. 10,608,672; 10,608,673; 10,944,601; and 11,095,314.

By some (e.g. out-of-band) signaling, we assume that the demodulator knows how many bits it needs to receive. First, the demodulator finds an estimate of the transmitted symbol sequence using the decision regions. Afterwards, it converts the result into a bit sequence. It checks the length of the bit sequence against the expected value. If they are the same, then the found symbol sequence is returned. If the lengths are not the same, then we list the demodulated symbols from least likely to most likely. Starting from the least likely, we look at what happens to the length of the bit sequence if we switch the demodulated symbol to a symbol on its own ring or a neighboring ring. If there is a bit sequence of correct length, then we switch the original demodulated symbol with the most likely symbol on these specified energy levels and the resulting symbol sequence is returned. If there is no bit sequence of correct length, we pass to the next least likely demodulated symbol and find out how the lengths will change again by a switch. This process continues until a bit sequence of correct length is found or we exhaust all the demodulated symbols. In the latter case, we return the original demodulation without performing any cleaning. Algorithm 2 illustrates how the correction operation is carried out.

Algorithm 2: Demodulation and Length Correction

| Input: | y: channel output | | |
|---|---|---|---|
| | C: constellation points and their probabilities | | |
| | f: symbol to bit mapping | | |
| | N₀: noise power | | |
| | n: number of transmitted bits | | |
| Result: \hat{x}: demodulated bit sequence | | | |
| ŷ ← MAP demodulation | | | |
| \hat{x} ← bit sequence corresponding to ŷ | | | |
| if \hat{x},length == n then | | | |
| \| | return \hat{x} | | |
| else | | | |
| \| | i ← 0, r ← likelihood order of symbols in y | | |
| \| | while i < ŷ.length do | | |
| \| | \| | [symbol] ← set of constellation points on the same | |
| \| | \| | ring and the neighboring rings | |
| \| | \| | p ← likelihood order of elements in [symbol] | |
| \| | \| | for j= l to p.length do | |
| \| | \| | \| | \hat{x} ← bit sequence of ŷ[r(i)] = p(j) |
| \| | \| | \| | if \hat{x}.length == n then |
| \| | \| | \| | \| return \hat{x} |

| | | |
|---|---|---|
| \| | \| | end |
| \| | \| | i ← i + 1 |

| | |
|---|---|
| \| | end |
| \| | return \hat{x} |

end

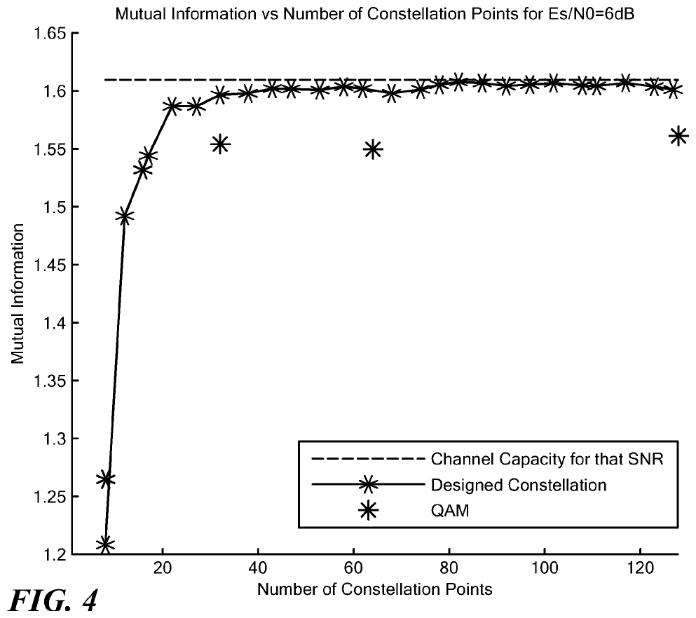

RESULTS. In this section, we represent the performance of the constellation design and the system we are using in comparison with QAM, which is a standard in many applications. FIG. 4 illustrates the mutual information we may obtain using the tailored constellation for Eₛ/N₀=6 dB and QAM. Rather than depending on the modulator and the demodulator designs, this result depicts the theoretical performance that can be achieved. After a certain discretization granularity, the performance converges to the capacity of the particular design whereas mutual information obtained by QAM remains suboptimal.

For the below performance results, it is useful first to provide a definition for E_{b}/N₀. In a usual modulation scheme, we use the following relation

$$\frac{{E}_{s}}{{N}_{0}} = \frac{{E}_{b}}{{N}_{0}} {log}_{2} ( K ) \qquad ( 10 )$$

between signal-to-noise (SNR) per symbol and SNR per bit, with K being the size of the constellation. In conventional constellations, the number of bits reserved for each symbol is the same and equal to log₂ (K). By contrast, in our constellations, the number of bits used to represent a symbol may differ even at the same energy level. That is why the conventional equations to calculate the SNR per bit does not hold. So, instead of the factor log₂ (K), we use the entropy of the constellation. Therefore, in accordance with embodiments disclosed herein, equation (10) becomes

$$\frac{{E}_{s}}{{N}_{0}} = \frac{{E}_{b}}{{N}_{0}} {\sum }_{i = 1}^{K} - {p}_{i} {log}_{2} ( {p}_{i} ) \qquad ( 11 )$$

It should be noted that the length of the bit sequence representing the jth symbol is equal to −log₂(pⱼ), so the entropy is equivalent to the mean length of the bit sequences.

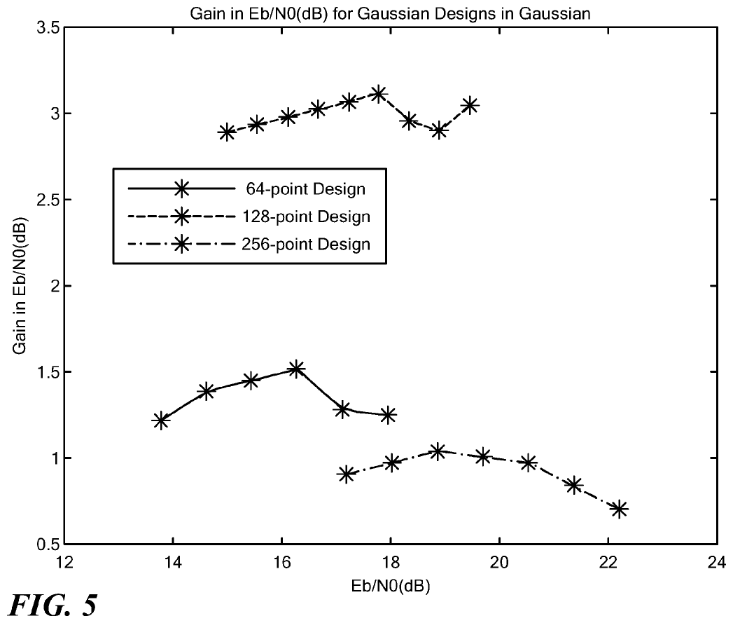

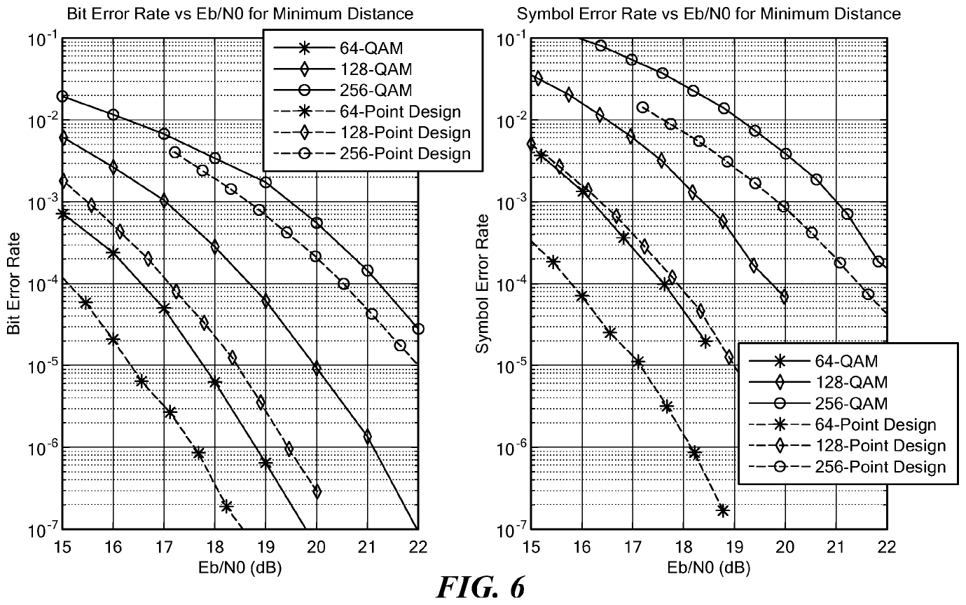

FIG. 5 displays the gain in E_{b}/N₀ that we can obtain by using the overall system proposed in this paper compared to QAM of same sizes in an uncoded setting. The y-axis represents the difference in E_{b}/N₀ that obtains the same bit error rate (“BER”) value between the tailored constellation and QAM. FIG. 6 displays the uncoded performance of the constellations designed for Eₛ/N₀=26 dB in comparison with the performance of the QAM constellation for some commonly used constellation sizes for different channel noise levels. The energy levels used for 64-point, 128-point and 256-point are as {a∈Q:a=0.7k, k≤10, k∈N}, {a∈Q:a=0.6k, k≤10, k∈N} and {a∈Q:a=0.4k, k<10, k∈N}, respectively. FIG. 6 indicates a performance gain in all three constellation sizes both in terms of BER and symbol error rate (“SER”).

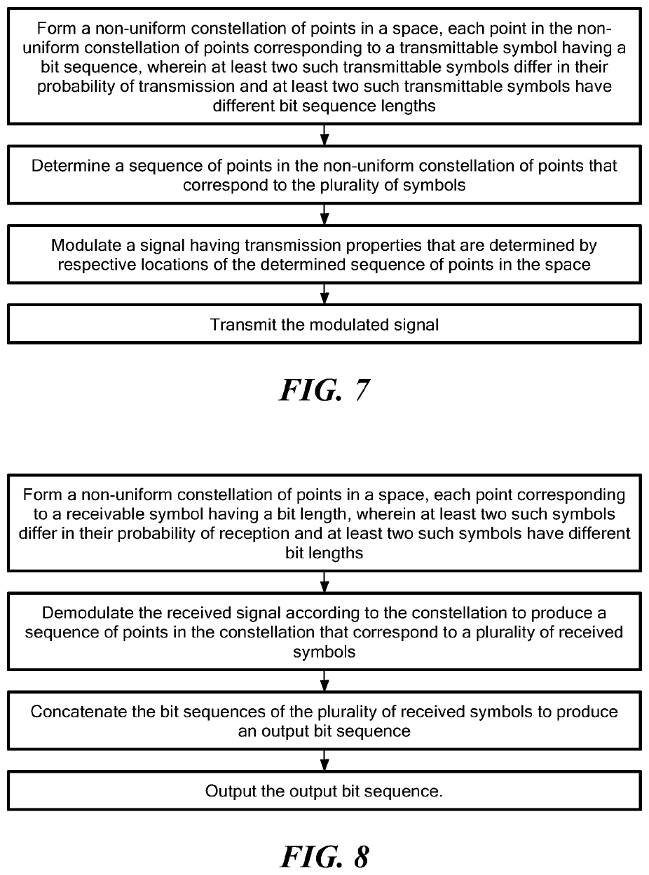

In view of the above, FIG. 7 is a flowchart showing a method of modulating a plurality of symbols for transmission in accordance with an embodiment as described in more detail above. The method of modulating begins by forming a non-uniform constellation of points in a space, each point in the non-uniform constellation of points corresponding to a transmittable symbol having a bit sequence, wherein at least two such transmittable symbols differ in their probability of transmission and at least two such transmittable symbols have different bit sequence lengths. The method continues by determining a sequence of points in the non-uniform constellation of points that correspond to the plurality of symbols. The method proceeds to modulating a signal having transmission properties that are determined by respective locations of the determined sequence of points in the space. Finally, the method requires transmitting the modulated signal. Various aspects of this method of modulating may incorporate the concepts, techniques, and structures described above.

Likewise, FIG. 8 is a flowchart showing a corresponding method of demodulating a received signal that encodes a plurality of symbols in accordance with an embodiment. The method of demodulating begins in the same manner as the method of FIG. 7; that is, by forming a non-uniform constellation of points in a space, each point corresponding to a receivable symbol having a bit length, wherein at least two such symbols differ in their probability of reception and at least two such symbols have different bit lengths. Next, the method continues by demodulating the received signal according to the constellation to produce a sequence of points in the constellation that correspond to a plurality of received symbols. Then, the method proceeds by concatenating the bit sequences of the plurality of received symbols to produce an output bit sequence. Finally, the method requires outputting the output bit sequence. Various aspects of this method of demodulating may incorporate the concepts, techniques, and structures described above.

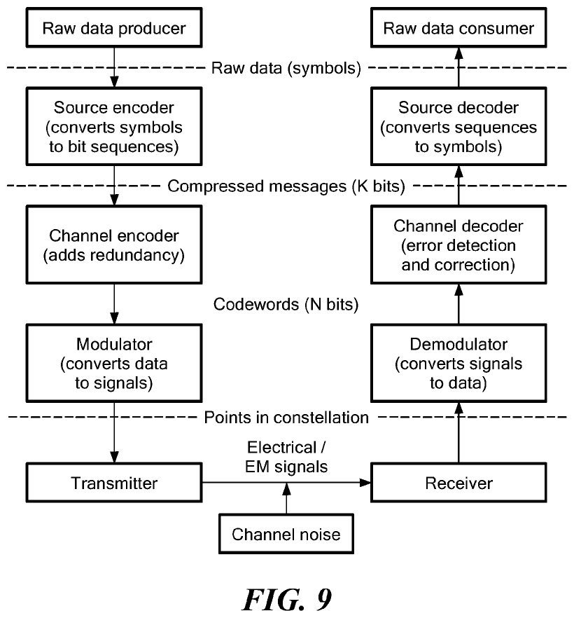

FIG. 9 shows a system for transmitting data symbols between a data producer and a data consumer in which embodiments of the concepts, techniques, and structures disclosed above may be advantageously used. On the left is shown a raw data producer, on the right is shown a raw data consumer, and between them is shown the data path through a noisy channel as described above. The raw data producer and raw data consumer may be any electronic devices known in the art (e.g. computers) that produce and consume data.

The raw data producer operates on raw data as symbols. The symbols may be any encoding of the raw data, including without limitation ASCII text, raw image data, raw audio data, or any other sort of data. It is common for these symbols to be compressed by a source encoder, thereby reducing the volume of data used to contain their information content. Doing so advantageously reduces the electronic resources (e.g. time and energy) needed for their transmission.

Thus, the raw data producer provides symbols of raw data to a source encoder. The source encoder converts symbols to bit sequences using a compression algorithm. Illustratively, raw pixel data may be converted into compressed image files, and raw audio data may be converted into compressed audio files. Such compression algorithms are known in the art, and not described further here. In many cases, the compressed data are stored locally (i.e. on the computer that generated them) without further processing, on the assumption that they may be retrieved from storage without error. However, for transmission over a noisy data channel to another electronic device, further processing is required.

To provide error detection and correction over a noisy data channel, compressed messages obtained from a source encoder are provided to a channel encoder. The channel encoder adds redundancy to the compressed messages to form codewords. Codewords of a given bit length form only a subset of all strings of bits having that length, and thus a membership function may be used to determine which bit strings represent codewords. Obtaining a string that does not represent a codeword indicates that an error has occurred (error detection), and thus a process to correct the error may begin. In channel encoders that use systematic codes, the bits of the received message form the beginning of the output codeword, while the remaining bits are redundant and permit error detection and correction.

Once the data have been prepared for error detection and correction, their bits are provided to a modulator for conversion from logical values into values that may be physically realized in a data communication medium. In particular, the modulator may convert bit values to in-phase and quadrature values on an I-Q plane in accordance with embodiments described above. Such values are associated with points in a constellation of points in the I-Q plane, and thus the modulator maps input codewords onto output points.

Constellation points are provided to a data transmitter, which converts them into physical signals. These signals may be electrical, electromagnetic, magnetic, optical, or use some other signaling technique. Transmitters for converting constellation points into physical signals are well-known, and are not described further here. The physical signals are transmitted through a noisy data channel to a receiver.

Once received, the physical signals undergo a process to reverse all of the manipulations described above. Thus, the receiver maps received physical signals onto respective points in the same constellation of points used by the transmitter. Embodiments of the concepts, techniques, and structures described above provide advantageous modes of detecting and correcting errors even at this early stage of decoding. Constellation points are provided to a demodulator, which converts these signals to codewords.

The codewords are passed to a channel decoder which detects and corrects any remaining errors. Illustratively, in cases of systematic codes where no error is present, the demodulator simply extracts the beginning of the codeword as the message; otherwise, an error correction algorithm is employed. Such algorithms are well-known, and not described herein.

Compressed messages output by the channel decoder may be stored on the consumer electronic device for later consumption, or consumed immediately. In either case, they are provided to a source decoder which decodes the compressed messages into uncompressed, raw data symbols that are amenable for computational use by the raw data consumer.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

In illustrative implementations of the concepts described herein, one or more computers (e.g., integrated circuits, microcontrollers, controllers, microprocessors, processors, field-programmable-gate arrays, personal computers, onboard computers, remote computers, servers, network hosts, or client computers) may be programmed and specially adapted: (1) to perform any computation, calculation, program or algorithm described or implied above; (2) to receive signals indicative of human input; (3) to output signals for controlling transducers for outputting information in human perceivable format; (4) to process data, to perform computations, to execute any algorithm or software, and (5) to control the read or write of data to and from memory devices. The one or more computers may be connected to each other or to other components in the system either: (a) wirelessly, (b) by wired or fiber optic connection, or (c) by any combination of wired, fiber optic or wireless connections.

In illustrative implementations of the concepts described herein, one or more computers may be programmed to perform any and all computations, calculations, programs and algorithms described or implied above, and any and all functions described in the immediately preceding paragraph. Likewise, in illustrative implementations of the concepts described herein, one or more non-transitory, machine-accessible media may have instructions encoded thereon for one or more computers to perform any and all computations, calculations, programs and algorithms described or implied above, and any and all functions described in the immediately preceding paragraph.

For example, in some cases: (a) a machine-accessible medium may have instructions encoded thereon that specify steps in a software program; and (b) the computer may access the instructions encoded on the machine-accessible medium, in order to determine steps to execute in the software program. In illustrative implementations, the machine-accessible medium may comprise a tangible non-transitory medium. In some cases, the machine-accessible medium may comprise (a) a memory unit or (b) an auxiliary memory storage device. For example, in some cases, while a program is executing, a control unit in a computer may fetch the next coded instruction from memory.

In some cases, one or more computers are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), or wireless communication standard, including IEEE 802.11 (Wi-Fi®), IEEE 802.15(Bluetooth®/Zigbee®), IEEE 802.16, IEEE 802.20, GSM (global system for mobile communications), UMTS (universal mobile telecommunication system), CDMA (code division multiple access, including IS-95, IS-2000, and WCDMA), LTE (long term evolution), or 5G (e.g., ITU IMT-2020).

Features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

As used herein, “including” means including without limitation. As used herein, the terms “a” and “an”, when modifying a noun, do not imply that only one of the noun exists. As used herein, unless the context clearly indicates otherwise, “or” means and/or. For example, A or B is true if A is true, or B is true, or both A and B are true. As used herein, “for example”, “for instance”, “e.g.”, and “such as” refer to non-limiting examples that are not exclusive examples. The word “consists” (and variants thereof) are to be give the same meaning as the word “comprises” or “includes” (or variants thereof).

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the specification to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

We claim:

1. A method of demodulating a received signal that encodes a plurality of symbols, the method comprising:
forming a non-uniform constellation of points in a space, each point corresponding to a receivable symbol having a bit length, wherein at least two such symbols differ in their probability of reception and at least two such symbols have different bit lengths;
demodulating the received signal according to the constellation to produce a sequence of points in the constellation that correspond to a plurality of received symbols;
concatenating the bit sequences of the plurality of received symbols to produce an output bit sequence; and
outputting the output bit sequence.

2. The method of claim 1, further comprising receiving, from a modulator, data indicating a transmission bit length.

3. The method of claim 2, wherein concatenating the bit sequences comprises, when a total length of the produced output bit sequence differs from the transmission bit length:
guessing a noise associated with each point in the sequence of points;
selecting, as a function of the guessed noises, (a) a symbol in the sequence of received symbols, and (b) a replacement symbol having a different bit length, wherein the selected symbol and the selected replacement symbol have different bit lengths; and
replacing the selected symbol with the selected replacement symbol, when doing so would result in an output bit sequence having a bit length that equals the transmission bit length.

4. The method of claim 3, wherein selecting the symbol in the sequence of received symbols comprises selecting the symbol having a least likelihood of reception according to the guessed noises.

5. The method of claim 1, wherein the output bit sequence comprises a source encoding of a codeword.

6. The method of claim 5, wherein the source encoding comprises a Huffman encoding or algebraic code.

7. The method of claim 1, wherein forming the constellation comprises each point corresponding to a transmittable symbol having a bit sequence that is chosen on the basis of a Huffman distance between the bit sequence and the bit sequences of symbols that correspond to one or more nearest constellation points.

8. The method of claim 7, wherein forming the constellation in the space comprises assigning, to a given point, a symbol having a given bit sequence length when the point closest in the space to the given point corresponds to a symbol having the given bit sequence length.

9. The method of claim 1, wherein forming the non-uniform constellation of points comprises forming rings of points in the plane, each ring of points having points that are equiangularly or quasi-equiangularly distributed.

10. The method of claim 9, wherein forming the non-uniform constellation of points comprises increasing a minimum distance between points in adjacent rings

11. The method of claim 1, wherein producing the sequence of points in the constellation includes performing a maximum a posteriori (MAP) or quasi MAP estimation.

12. A system for demodulating a signal that encodes a plurality of symbols, the system comprising:
a receiver for receiving the signal according to a non-uniform constellation of points in a space, each point corresponding to a receivable symbol having a bit length, wherein at least two such symbols differ in their probability of reception and at least two such symbols have different bit lengths; and
a demodulator for demodulating the received signal according to the constellation to produce a sequence of points in the constellation that correspond to a plurality of received symbols, and for concatenating the bit sequences of the plurality of received symbols to produce an output bit sequence, and for outputting the output bit sequence.

13. The system of claim 12, wherein the demodulator is configured for, when a total length of the produced output bit sequence differs from a transmission bit length:
guessing a noise associated with each point in the sequence of points;
selecting, as a function of the guessed noises, (a) a symbol in the sequence of received symbols, and (b) a replacement symbol having a different bit length, wherein the selected symbol and the selected replacement symbol have different bit lengths; and
replacing the selected symbol with the selected replacement symbol, when doing so would result in an output bit sequence having a bit length that equals the transmission bit length.

14. The system of claim 13, wherein the demodulator is configured for selecting the symbol in the sequence of received symbols by selecting the symbol having a least likelihood of reception according to the guessed noises.

15. The system of claim 12, wherein the demodulator is configured for outputting an output bit sequence comprising a source encoding of a codeword.

16. The system of claim 15, wherein the source encoding comprises a Huffman encoding or algebraic code.

17. The system of claim 12, wherein in the non-uniform constellation of points, each point corresponds to a transmittable symbol having a bit sequence that is chosen on the basis of a Huffman distance between the bit sequence and the bit sequences of symbols that correspond to one or more nearest constellation points.

18. The system of claim 17, wherein the non-uniform constellation of points in the space comprises, for a given point, a symbol having a given bit sequence length when the point closest in the space to the given point corresponds to a symbol having the given bit sequence length.

19. The system of claim 12, wherein the non-uniform constellation of points comprises rings of points in the plane, each ring of points having points that are equiangularly or quasi-equiangularly distributed.

20. The system of claim 1, wherein the demodulator producing the sequence of points in the constellation includes the demodulator performing a maximum a posteriori (MAP) or quasi MAP estimation.
